(19) United States
(12) Patent Application Publication
(10) Pub. No.: US 2007/0210518 A1
(43) Pub. Date: Sep. 13, 2007

(54) Number game

(76) Inventor: Jacinta Maria Lawson, Bronx, NY (US)

Correspondence Address: Jacinta M. Lawson;Apt. # 5J, 600 Concord Avenue, Bronx, NY, 10455, US

(21) Appl. No.: 11/418,729

(22) Filed: May 5, 2006

Related U.S. Application Data
(60) Provisional application No. 60/782,326, filed on Mar. 13, 2006.

(51) Int. Cl. G09B 19/02; A63F 1/00; A63F 1/02

(52) U.S. Cl. 273/292; 273/296; 434/188

(57) ABSTRACT

I Jacinta Lawson designed a game in which two players take turn making five moves that will place their chosen numbered cell into their allowed position in the invention. Their chosen numbered cell must be a cell the when summed with any previously played number that is next to it (up, diagonally, and across) will give a sum that is in the Game Objective (a sum that is a Prime, Even, or Odd number). Each sum will be given (+2 pts) points when the Game's Objective is achieved and (−2 pts) when not. These points will be added to the Player's Total. The players can only choose numbers 0 through 9 inclusively. Once a number is used, it will is eliminated from the choices. Then game Winner is the player with the highest positive Total once all the numbers are played.

### BACKGROUND OF THE INVENTION

I must define the Classifications of Numbers as they are classified in Mathematics.

Positive Integers (Natural Numbers): (+1, +2, +3, +4, +5, +6, +7, +8, +9, +10, . . . ). The (+) sign is sometimes not displayed.

Negative Numbers (Natural Numbers): (−1, −2, −3, −4, −5, −6, −7, −8, −9, −10, . . . )

Whole Numbers: (0 and positive integers)

Prime Number: a Whole number other than 0 and 1 which is divisible (no remainder) only by 1 and itself (Ex: 2, 3, 5)

Even (Composite) Numbers are Whole Numbers divisible by 2.

Odd numbers are numbers that are neither Prime nor Composite Numbers. (Ex: 9)

The Number Game makes a game out of the fact that when you add composite, odd, and prime numbers with each other or themselves you get numbers that are in either number classification. The Number Game does this:

1). in FIG. 1f, and FIG. 7, the physical table I am describing in this application which has moveable numbered cells (FIGS. 1b and 3) allowing users to carry it around and play the game.

2) by allowing people to draw a 2×5 or 5×2 table anywhere. And

3). in a Computerized version of the game.

Problems: Everyone hates Math especially adding signed numbers and it is very hard to Fig. out what are Prime, Composite, and Even Numbers. Also Sometimes people can't or do not want to write.

### BRIEF SUMMARY OF THE INVENTION

Problems: Everyone hates Math especially adding signed numbers and it is very hard to Figure out what are Prime, Composite and Odd Numbers. Sometime people can not or do not want to write to play the game as is suggested on page 16 of this paper.

Invention: Number Game solves these problems because players get to practice adding signed numbers and learning how to classify numbers as prime, even, and odd numbers. Also, by writing a computerized version of the game or constructing a rectangular game piece FIGS. 1e (6, 7 and 8), players will have a game they can carry around and not worry about caring pen and paper or writing when they can not or do not want to.

Last of all, in the computerized version players have the opportunity to play against a computer if no one else is available, giving them another chance to learn from or teach an expert.

### BRIEF DESCRIPTION OF THE SEVERAL VIEWS OF THE DRAWING

FIG. 1a is a drawing of one of the rectangular cells that will have numbers and be moved around to play the Number Game, FIG. 2 is a 3D version of FIG. 1a.

FIG. 1b is a drawing of FIG. 1a with a number on it. FIG. 3 is a 3D drawing of FIG. 1b.

FIG. 1c a drawing of all 11 rectangular (FIGS. (1a and 1b)) cells. Ten of the figures in 1c will be FIG. 1b's and one will be FIG. 1a.

FIG. 4 is a 3D version of FIG. 1c. These are the cells that will be moved around to play the Number Game.

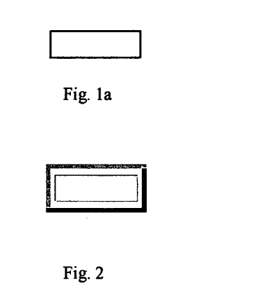

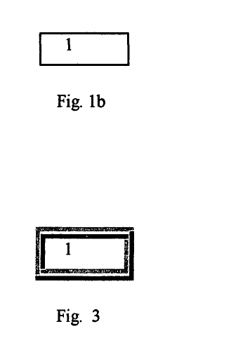

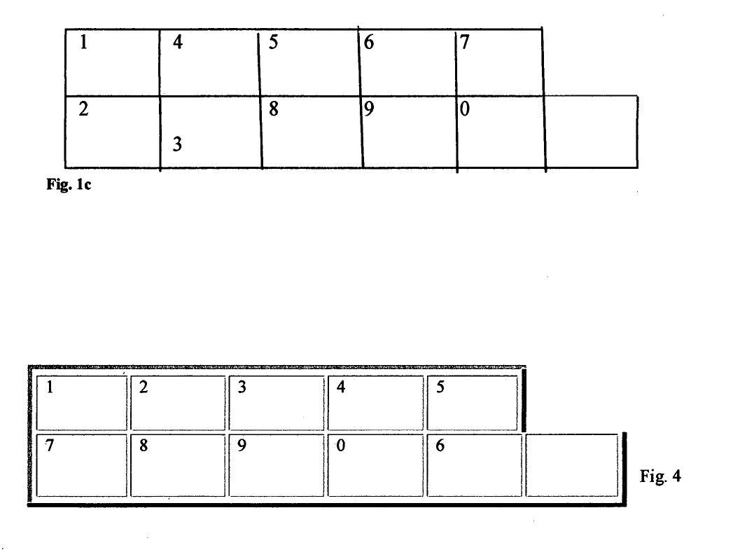

FIG. 1d is a drawing of the plastic casing that will hold FIG. 1c. FIG. 5 is the 3D version of 1d. FIG. 6 is a vertical view of FIG. 5.

1e is a covering that will be put over the 1d when 1c id put in 1d. It will keep the cells in and will be bonded to 1d.

Completed game piece, Number Game, FIG. 1f is a drawing of how FIG. 1c will look in 1d covered by 1e (3D version FIG. 7 and vertical FIG. 8. This is also how FIGS. (1a and 1b) put together to make and FIG. 1c placed in FIG. 1d, covered by FIG. 1e to make 1f will look. FIG. 7 the 3D version is how FIGS. 2, 3 and 4 will look when they are encased in FIG. 5 covered by FIG. 1e, to make the game piece, Invention (Number Game), vertical view FIG. 8

### DETAILED DESCRIPTION OF THE INVENTION

FIG. 1a and its 3d version 2 should be rectangular shaped and made of thin, smooth, white, and hard plastic, each of which will be of the following dimension:

Width= 1/16 inch

Length=1 in

Depth=½ in.

FIG. 1b and the 1b version, 3, is a drawing of FIGS. 1a and 2 with an embedded number on it. The numbers on the cells will be made with permanent black colored ink. Dimensions:

Length=¼ in long

Width=½ in thick.

FIG. 1c is a drawing often FIG. 1b and one FIG. 1a.

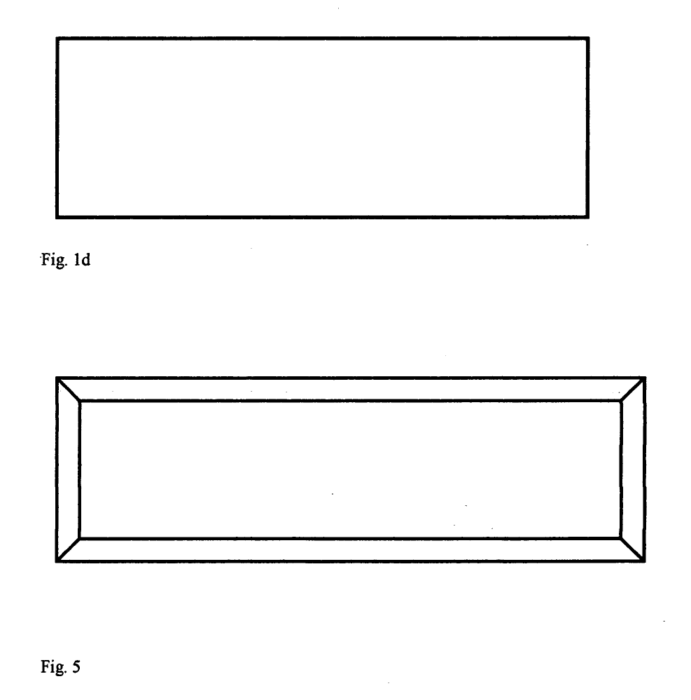

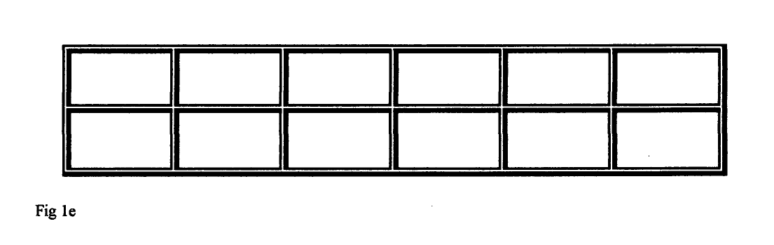

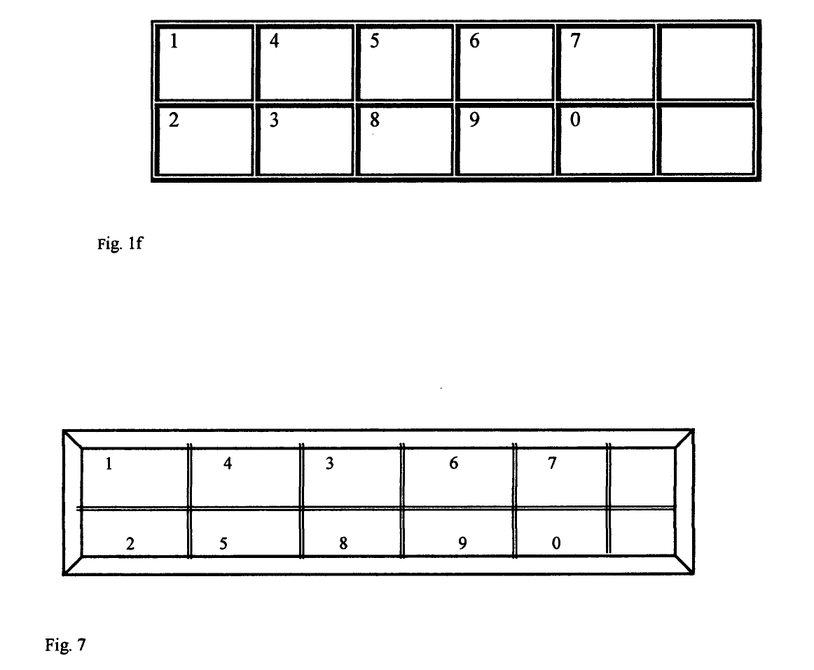

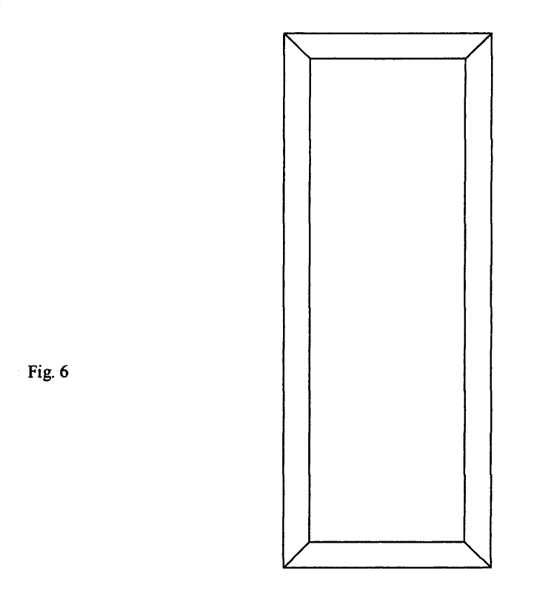

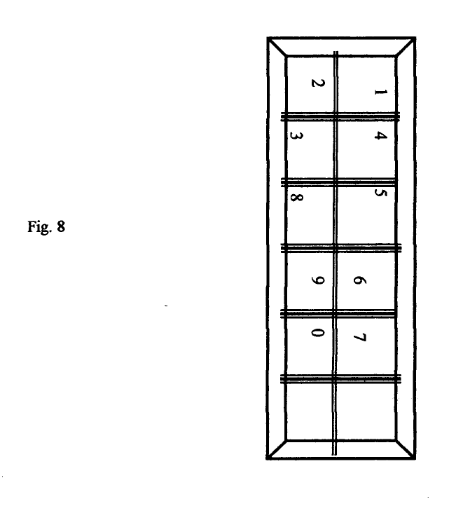

In 3D it will be 10 FIG. 3's and one FIG. 2 put together to be FIG. 4. These are the 11 cells that players will moved around to play the Number Game.

FIG. 1d is a drawing of the plastic casing that will hold all the figures shown in FIG. 1c. FIG. 5 is a 3D version of FIG. 1d. FIG. 6 is a vertical view of FIG. 5. FIGS. 1d (5 and 6) will be a blue collard, smooth, hard plastic with dimensions:

Width (thickness)= 1/16 in.

Length=6 3/16 in

Depth (height)=1⅛ in

FIG. 1e will be the boarders that will hold in 11 FIGS. (1a and 1b) inside 1d and allow them to move around. The thin white plastic boarders will be

Width= 1/16 inch

Length=1 1/32 in

Depth=⅝ in

With a ⅞ by ⅜ square cut out of it

This construction of FIG. 1e e will be multiplied by 12 so that it hold all 12 FIGS. 1a and 1b in place and allows them to move from cell to cell in the table FIG. 1f. All twelve sections would be a single piece that would end up looking like 1e. 1e will hold all pieces in FIG. 1c in place while allowing them to move and allows them to be seen. The hollowed cells, that covers the case (FIG. 1d) should be made separate then inserted back into 1d after all figures in FIG. 1c are inserted.

FIG. 1f is a drawing of how FIG. 1c, will look when encased in FIG. 1d covered with FIG. 1e to make the game piece or Invention (Number Game). FIG. 7 is the 3D version of 1f and FIG. 8 is a vertical view of FIG. 7

I Jacinta Lawson am designing a game called, Number Game. In this game the two players will have to decide whether the Game's Objective is to make a sum that is Prime, Even (Composite), or Odd number. Next, each of two players in his turn, will in putting any of ten numbers (0 through 9 inclusively) with no duplicate number entry into a (2×5 or 5×2 table).

The invention described in this application will be a thin rectangular plastic game piece which has its edges raised FIGS. (1e, 7, and 8) so that it can encase 11 smaller rectangular cells FIGS. (1a and 1b) made out of the same plastic material and a missing cell. On 10 of the 11 small rectangular plastic cells, the numbers 0 to 9 (FIGS. 1b and 3) will be written on them. The 11^{th} cell will have no number (FIGS. 1a and 2). The 12^{th} cell will be a missing (FIG. 1e “Empty”)

This cell is missing to allow movement of the other cells in the invention which is what players need to do in order to get their cell next to already played cell which when added together gives sums in the Game's Objective.

The drawing of this construction is included with Fig. notation pages 23-30

Here is an example of a game played in the plastic game piece FIG. 1f Below are the order (positions) players must play.

| | | | | | |
|---|---|---|---|---|---|
| Player 1 | Player 1 | Player 1 | Player 1 | Player 1 | Blank |
| (1^{st} position) | (3^{rd} position) | 5^{th} | 7^{th} | 8^{th} | 9^{th} |
| Player 2 | Player 2 | Player 2 | Player 2 | Player 2 | Empty |
| (2^{nd}) | (4^{th}) | 6^{th} | (8^{th}) | 9^{th} | 10^{th} |

The Number Game begins when a player scrambles or mixes up the numbers, 1b in rectangular game piece 1f. Next the players choose the Game's Objective. Say the game objective chosen is Even (Composite) numbers.

Player 1 makes five moves but only manages to move a 1 into his (first) position

| | | | | | |
|---|---|---|---|---|---|
| 1 | 5 | 2 | 6 | 7 | 8 |
| 0 | 3 | | | 4 | 9 |

Player 1 gets (−2 points) because 1 is not a composite number. His Total=(−2)
Now it is Player 2's turn. He makes five moves.

Player 2 gets a cell with a 3 on it (FIG. 3) into the 2^{nd} (his designated) position.

| | | | | | |
|---|---|---|---|---|---|
| 1 | 0 | 5 | 2 | 8 | 7 |
| 3 | | 6 | | 4 | 9 |

Player 2 gets +2 points since 1+3=composite number (Game's Objective achieved). Player 2's Total=+2

Now it is Player 1's turn and he moves cell number 5 into his position (3^{rd} position) making less than five moves.

| | | | | | |
|---|---|---|---|---|---|
| 1 | 5 | 6 | 2 | 8 | 7 |
| 3 | 0 | | | 4 | 9 |

Player 1 get (+2) points since 1+5=Composite number and he will get (+2) more points since 3+5=composite number. The game objective was achieved in both cases. Player 1's Now has a total of Total=(+2 )+(+2)=+4+(previous Total (−2))=+2

Next Player 2 moves cell number 6 into the fourth cell after 5 moves.

| | | | | | |
|---|---|---|---|---|---|
| 1 | 5 | | 2 | 8 | 7 |
| 3 | 6 | 0 | | 4 | 9 |

Player 2's score is 5+6=not composite (score=−2 pts), 1+6=not composite (score=−2 pts), 3+6=not composite (score=−2) Player 2 Total=(−2)+(−2)+(−2)=−6 added to his previous Total (+2 ) +(−6)=−4 . . . Total=−4

The players will continue this procedure until they have played all 10 numbers. The player with the greatest positive total is the winner.

If the game is played by making a table with two rows and five columns everything will be the same except the players will be allowed to put their number in any vacant cell. Here are the instructions.

INSTRUCTION for

A computer generated Number Game OR

A game constructed on paper (game played by making a table.)

1) Players decide if they want to

Draw this table

| | | | |
|---|---|---|---|
| 1 | 1 | 1 | 1 |
| 1 | 1 | 1 | 1 |

Or DRAW table
2) 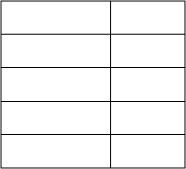
   In either case the game is played as written below.
3) Choose game objective: Prime, Odd, and Even
4) Numbers to choose from are 1, 2, 0 3, 4, 5, 6, 7, 8, 9
5) Player 1 and 2 take turn placing numbers in each cell. Player 1 and 2 can place numbers in any unused cell. However they can only receive points (+2 if sum is in the “Game's Objective” and −2 if not) when they place a number next to a played.
   Game Played

Game Objective chosen is Composite (Even) Numbers

| | |
|---|---|
| 2 | 4 |
| 6 | 5 |

Player 1 starts the game in an empty table and puts in a 2.

Since there are no other numbers in the table and 2 is not a composite number, player scores −2 points. Therefore, Player 1's TOTAL=−2.

Player 2 inputs 4. Adding 4 to the cell next to it we get 4+2=Composite (even) number=(+2 points). Player 2's TOTAL=+2.

Player 1 inputs 6 in the table. 6+2 (the number up and next to it)=8=Composite=+2 points. The 6 Player 2 put in the table is also diagonally next to 4. So Player 2 adds 6+4=10=Composite (Game's Objective is achieved)=+2 more points. Player 1's TOTAL=previous Total (−2)+(+2)+(+2)=+2 TOTAL=+2

Player 2 inputs 5. Adding 5 to the cells next to it we get 5+6=non composite number=(−2 pts) 5+4=non composite number=(−2 pts) and 5+2=non composite number=(−2 pts). Player 2's TOTAL =previous Total (+2)+(−2)+(−2)+(−2)=(−4).

The players will continue this procedure until they have used up all 10 numbers. The player with the greatest total is the winner.

What I claim as my invention is called “Number Game”, described in application Ser. No. 11,418,729, which is a game that has rules that I will invent and a table that I will also invent to play this game:

1. Rules for playing the NUMBER GAME:
Step 1). Only the numbers 0-9 inclusive are permitted to play the NUMBER GAME. Each of these ten numbers is played only once per game.
Step 2). Players must pick a GAME OBJECTIVE SUM, which is to get a sum that is either a Prime Number or a Composite Number. In this step Players only chose the words Prime or Composite.
Step 3.) Player during his turn must move his cell into his designated position by moving one or more cells not previously played no more than five times.
Step 4) After the player plays, he must sum his number to the cell that was previously played and is immediately above his if there is one. This sum is evaluated and given +2 points if it is the selected Game Objective and −2 points if it is not. The player will do this same procedure if there is a number that was played and is immediately below his and again if one is immediately diagonally next to his.
Step 5). These points will be added to the Players cumulative Total.
Step 6). THE WINNER is the player with the greatest positive Total (highest total).
Step 7). Players may choose to make a 5×2 table and play the game by inserting Numbers 0 through 9 and follow the rules to win the game.

2. The table that I will invent to play the Number game will be designed to have 2 rows and 5 columns. The table that I will invent will have movable numbered cells to allow the players to play the game. This invented table is described in Application NO: 11,418,729 (all figures in previously amended Drawing 1-15).
